(19) United States
(12) Patent Application Publication
(10) Pub. No.: US 2025/0308046 A1
(43) Pub. Date: Oct. 2, 2025

(54) SYSTEMS AND METHODS FOR PERCEIVING DEPTH

(71) Applicant: Subterra AI, Inc., Cincinnati, OH (US)

(72) Inventor: Robert C. Lee, Cincinnati, OH (US)

(73) Assignee: Subterra AI, Inc., Cincinnati, OH (US)

(21) Appl. No.: 19/095,949

(22) Filed: Mar. 31, 2025

Related U.S. Application Data
(60) Provisional application No. 63/571,628, filed on Mar. 29, 2024.

(51) Int. Cl. G06T 7/50; G06T 5/50; G06T 7/70

(52) U.S. Cl. CPC G06T 7/50; G06T 5/50; G06T 7/70; G06T 2207/20221

(57) ABSTRACT

Methods for providing depth-related information for images captured by a monocular-type camera are provided herein. A camera can move through a confined space capturing video. An image from the video can be captured and processed using a machine learning algorithm that identifies a depth of field from the camera point of view. The location of the captured image can be used along with known or pre-learned dimension data for the location, to identify the depth of field distances to objects found in the image. This depth data can be overlaid onto the image, and an operator can use this information to measure anomalies found in the image.

### CROSS REFERENCE TO RELATED APPLICATIONS

This application claims priority to U.S. Ser. No. 63/571,628, entitled SYSTEMS AND METHODS FOR PERCEIVING DEPTH FROM A MONOCULAR CAMERA WITHIN A CONFINED SPACE USING MACHINE LEARNING TECHNIQUES, filed Mar. 29, 2024, which is incorporated herein by reference.

### BACKGROUND

Inspecting the condition of confined spaces, such as pipes, manholes and specifically collection systems, is a difficult and dangerous task. Inspection may be done manually or using tethered CCTV rovers and floats controlled from the surface using a cable. Measurements are needed to quantify the size and the extent of defects. Specialist equipment is usually attached to the existing CCTV rover and can consist of but not limited to laser line profiling tools and/or LIDAR. These inspection methods and data analysis are often slow, expensive, or dangerous.

### SUMMARY

Embodiments of the technology relate, in general, to perceiving a substantially accurate depth calculation, such as within a confined space, derived from a monocular image or video using machine learning. As described herein, systems and methods for a safe, cost-effective, efficient, objective, and accurate solution for inspecting and mapping confined areas, such as subterranean infrastructures. Alternatively, software tools can be used to extract and analyze data from existing solutions.

A depth perception method using machine learning. The method can comprise identifying a location of a camera taking a video in a confined space. Further, an image can be captured from the video at a designated location. The image can be processed using a depth perception algorithm. Image depth data can be developed based on the processed image. The image depth data can be overlaid onto the captured image, and a location of objects in the image can be identified based on the known location and the image depth data. Real-world coordinates can be determined for the objects in the image based on the identified location of the objects

### BRIEF DESCRIPTION OF THE DRAWINGS

The present disclosure will be more readily understood from a detailed description of some example embodiments taken in conjunction with the following figures:

FIG. 1 is a flow diagram depicting an example process of which to calculate depth from a monocular image.

FIG. 2 is an illustration depicting example steps of the process of the RAW image being compared to a prior 3D CAD model in the ML learning process.

FIG. 3 is a flow diagram depicting an example process of which to calculate depth from a monocular image using machine learning.

FIG. 4 are illustrations depicting an example operator screen grabbing an image from video to be uploaded to the cloud platform for it to undergo ML depth perception. It shows the process of calculating the depth in the cloud to then be sent back down as a depth image for the operator to measure from.

FIG. 5 is an image depicting an example ML depth perception being performed on a 360° image.

FIG. 6 is a flow chart depicting an example method of using an image that has undergone depth perception using the ML process and being accurately geolocated using the VSLAM process.

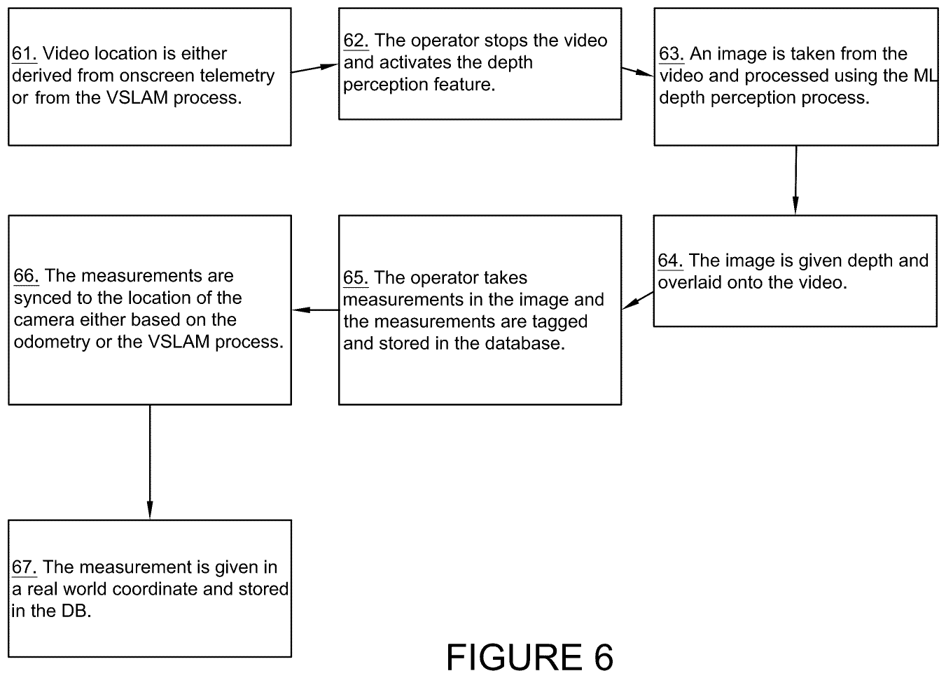

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Described herein are example embodiments of apparatuses, systems, and methods for remote inspection and mapping. The example embodiments described herein can provide remote inspection or mapping of a system, such as a subterranean system. In some embodiments where the system to be inspected includes liquid (e.g., a sewer system), the remote device can be configured to float through the system. In various embodiments, the system may be dry, partially filled with liquid or other material, or fully filled with liquid or other material. Remote inspection or mapping provided by example embodiments described herein reduces or eliminates the danger of manual inspection and can be easier to use, more cost-effective, and more accurate than existing inspection technology.

The examples discussed herein are only examples and are provided to assist in the explanation of the apparatuses, devices, systems and methods described herein. None of the features or components shown in the drawings or discussed below should be taken as mandatory for any specific implementation of any of these apparatuses, devices, systems or methods unless specifically designated as mandatory. For case of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel. Any dimension or example part called out in the figures are examples only, and the example embodiments described herein are not so limited.

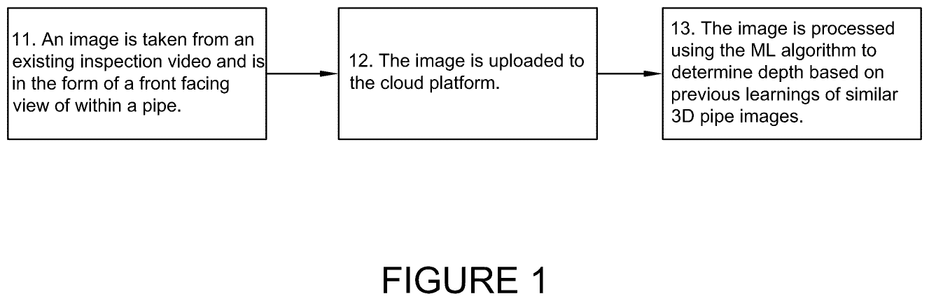

FIG. 1 Is a flowchart showing the process of which to calculate depth from a monocular image. The given nature of a camera looking down a pipe results in a fairly predictable measurement and can train a machine learning algorithm to perceive depth. At 11, An image is taken from an inspection video, in the form of a from facing point of view (POV) from a camera within a confined space, such as a pipe. The image may be captured from a portion of a video taken by the camera, such as from a single lens camera (e.g., non-stereoscopic). In this example, at 12, the captured image (e.g., and/or a plurality of sequential images) can be uploaded to a remote computing platform, such as a cloud-based computing platform. At 13, the image uploaded to the computing platform can be processed using a machine learning algorithm. The machine learning algorithm is configured to determine a depth of the space (e.g., and objects) depicted in the captured image, based at least on previous learning of similar three-dimensional (3D) images captured by similar cameras in similar situations. In this way, for example, a depth of the space, walls, objects, anomalies, etc. relative to each other and the POC can be identified without using a stereoscopic image.

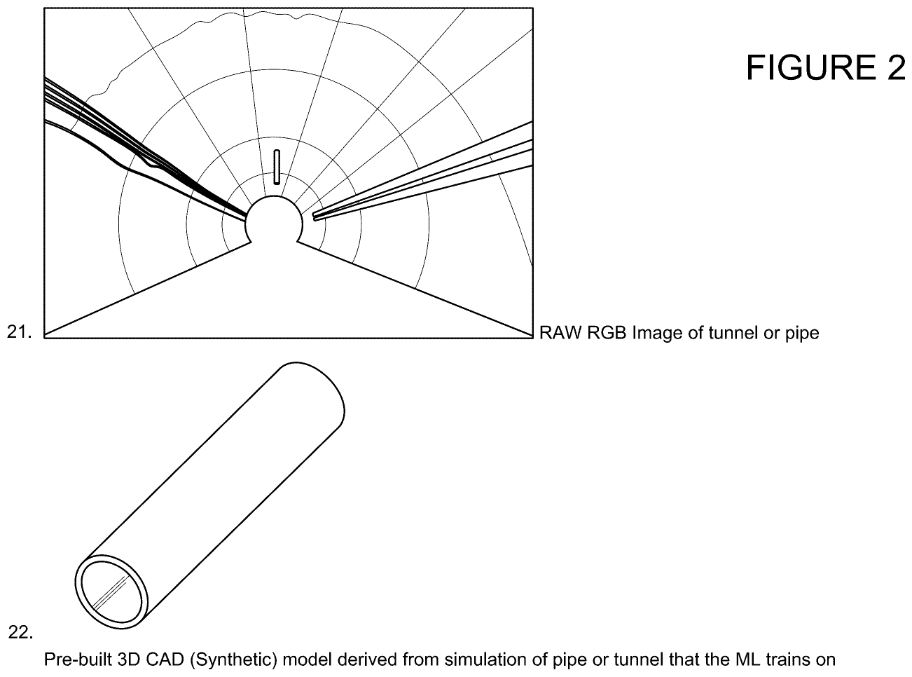

FIG. 2 illustrates a portion of a method of how to teach a ML algorithm using real world RAW RGB image data 21. Of a tunnel or pipe; along with 3D reconstructed CAD Models or synthetic data to perceive depth. By ascertaining the standard pipe sizes, one can reconstruct the pipe in 3D as a synthetic model, as shown in 22. For example, the operator can then place a virtual camera within the created pipe or tunnel to simulate an inspection camera going through the pipe. Different variables can be changed to aid in teaching the machine learning algorithm, such a anomalies, damage, blockages, diverging and converging pipes, pipes entering to a main section, etc. Once enough training has been completed with a high level of confidence that the ML algorithm can perceive depth in a pipe we can deploy it on real world applications.

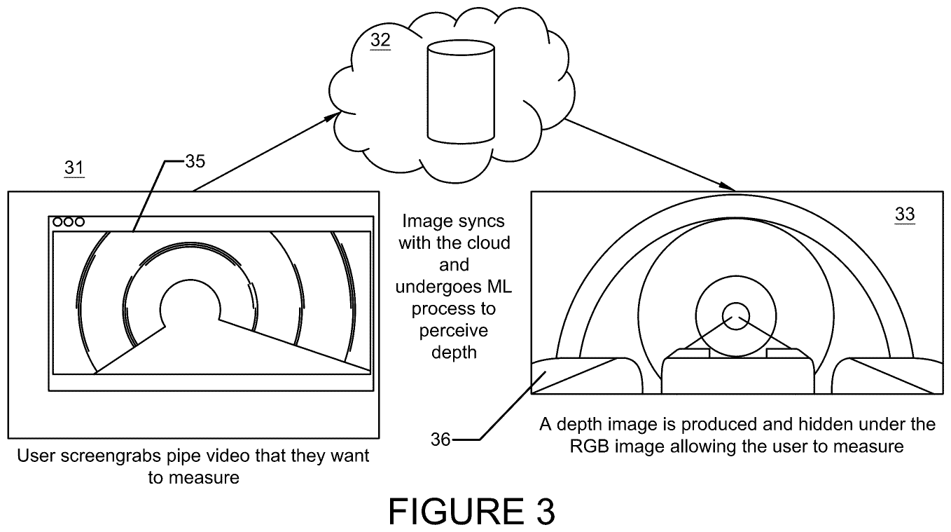

FIG. 3 shows the steps using the cloud-based computing platform, the ML algorithm and the operator to create measurements from a single front facing image from within a pipe. For one example, at 31, the operator can pause or stop the video taken by the monocular camera in the confined space to capture an image. The video may be downloaded or accessed from the cloud-based computing platform. The video can be stopped at a location of interest to the operator, such as a position at which they would like to measure the space, objects, etc. in the confined area. In this example, the operator can activate the depth tool and create a bounding box 35 around the area of interest in the video. An image grab is taken and sent to the cloud, at 32. The image, along with known information about the pipe, is run through the machine learning algorithm. Because the diameter of the pipe is known, the ML algorithm can perceive the depth from the real world, captured image. In this example, at 33, the depth image is sent back to the operator in the form of an RGB-D image 36. As an example, the operator can then make measurements from within the image as the depths and locations of objects, walls, etc., of the image is embedded in the processed image. As an example, the measurements can be stored in a cloud-based database for later reference. The geolocation of the portion of the pipe where the measurement is taken can also be stored.

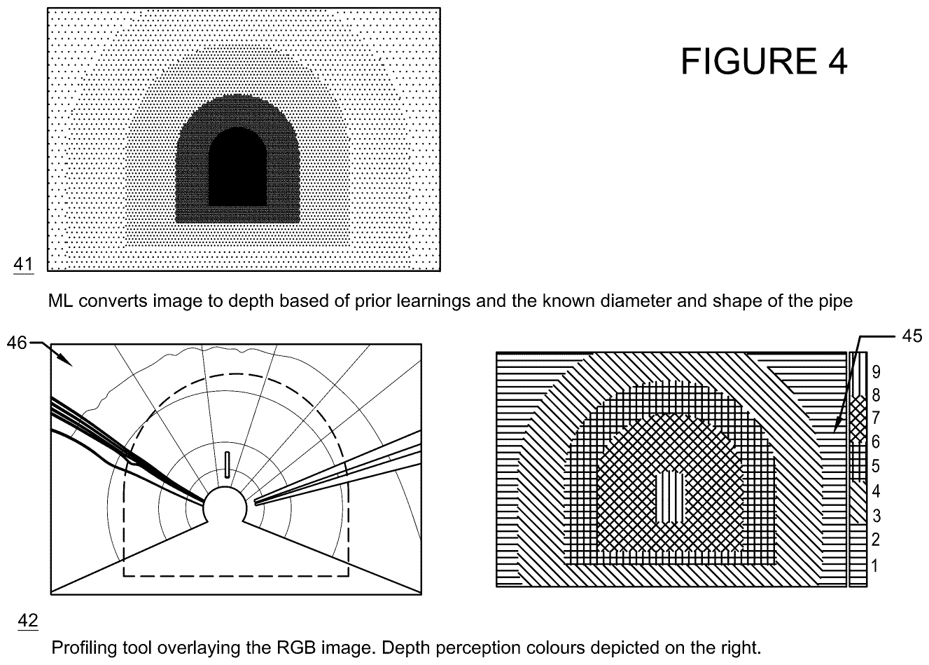

In some implementations, as illustrated in FIG. 4, the diameter and shape of the pipe or tunnel is known, and stored in the cloud-based computing platform. At 41, the image captured and sent to the cloud-based computing platform can be converted to a depth-based image based on the known information about the space, and the geo-location of the captured image. Thus, the image can be accurately converted in the depth image, providing appropriate depths from the camera POV to objects, walls, etc. in the space. As illustrated at 42, a depth perception image 45 can comprise colors depicting different depths from the camera POV to the objects in the image. The RGB image 46 can be overlayed over the depth perception image 45, to provide depths or distances from the POV camera to objects in the image.

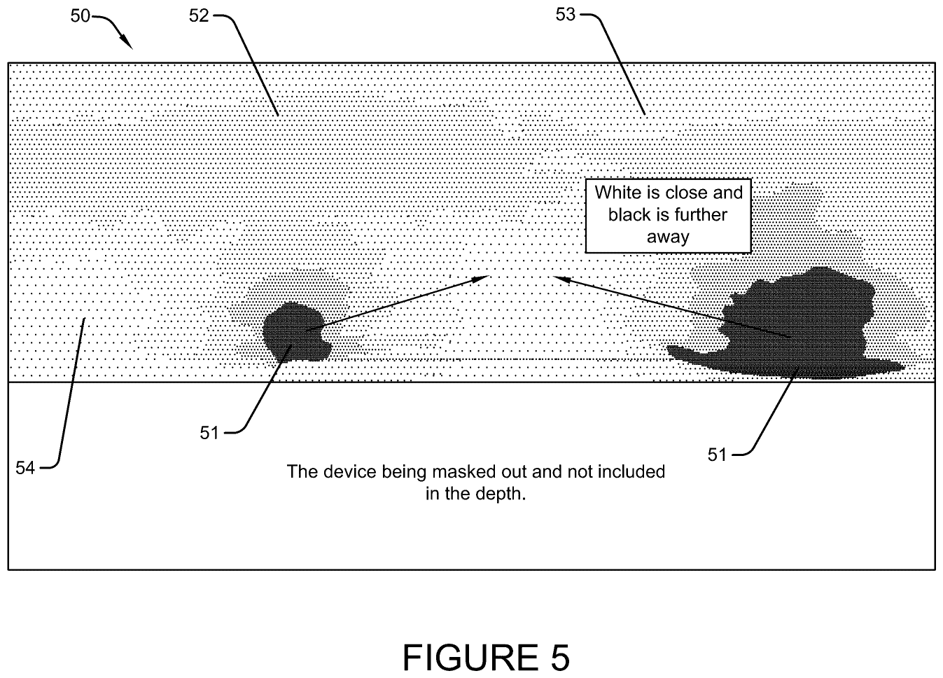

As another example, as illustrated in FIG. 5, the same method can be completed on 360° video and images. For example, in FIG. 5 there is a depiction of a RGB-D of a 360° image 50. In this example, lighter portions in the image 51 represent areas that are closer to the camera POV, such as from a light source at the camera. Further, areas that are further away are represented in darker colors, such as light gray for close intermediate 52, dark gray for far intermediate 53, and black for far 54. In this example, knowing that the Vanishing Points, dark portions 54, of the image are further away, and the light areas 51 of the wall are closer to the camera, an appropriate learning algorithm can be employed by the cloud-based platform. That is, these types of images 50 can be used to train the ML algorithm to identify depths from the camera POV, and later used to identify those depths in real-world images.

FIG. 5 shows a flowchart on the steps taken to geolocate a feature based on the ML depth perception calculation. At 61 a location of the video and/or portions of the video can be derived from onscreen telemetry (e.g., provided by geolocation) and/or by the VSLAM process. Visual SLAM (VSLAM) is a process that uses cameras to determine the position and orientation of a sensor while simultaneously mapping the surrounding environment. It involves capturing images, extracting features, and continuously updating the map and the sensor's location as it moves through space. At 62, the operator can stop the video and activate the depth perception feature. That is, the video may be accessed at the remote computing platform, and activation of the depth perception feature can be interlaced with the access of the video. The activation of the depth perception feature can automatically take a section of the video, or the operator may stop the video and activate the feature.

At 63, an image is taken from the video at the point of the activation of the depth perception feature. The image is process using the machine learning depth perception process, described herein. Further, at 66 the depth measurements and dimensions are determined for the objects in the image, and these depth perception images are overlaid onto the actual image. At 65, the operator can take measurements in the image and the measurements can be tagged and stored in the database. For example, the operator may identify an anomaly in the pipe, such as damage, a blockage, or prior unknown egress. The operator can take measurements of the size and location of the anomaly, which can then be tagged wand stored in the database.

Additionally, at 64, measurements for objects, such as walls, anomalies, etc., are synchronized to the known location of the image based on the odometry or the VSLAM process. In this way, real-world dimensions are known for the image and identified anomalies. At 67 The measurements identified are given real-world dimensions and coordinates, which are stored in the remote computing platform.

In general, it will be apparent to one of ordinary skill in the art that at least some of the embodiments described herein can be implemented using many different embodiments of software, firmware, and/or hardware. The software and firmware code can be executed by a processor or any other similar computing device. The software code or specialized control hardware that can be used to implement embodiments is not limiting. For example, embodiments described herein can be implemented in computer software using any suitable computer software language type, using, for example, conventional or object-oriented techniques. Such software can be stored on any type of suitable computer-readable medium or media, such as, for example, a magnetic or optical storage medium. The operation and behavior of the embodiments can be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes described herein can be executed by programmable equipment, such as computers or computer systems and/or processors. Software that can cause programmable equipment to execute processes can be stored in any storage device, such as, for example, a computer system (nonvolatile) memory, an optical disk, magnetic tape, or magnetic disk. Furthermore, at least some of the processes can be programmed when the computer system is manufactured or stored on various types of computer-readable media.

It can also be appreciated that certain portions of the processes described herein can be performed using instructions stored on a computer-readable medium or media that direct a computer system to perform the process steps. A computer-readable medium can include, for example, memory devices such as diskettes, compact discs (CDs), digital versatile discs (DVDs), optical disk drives, or hard disk drives. A computer-readable medium can also include memory storage that is physical, virtual, permanent, temporary, semi-permanent, and/or semi temporary.

A “computer,” “computer system,” “host,” “server,” or “processor” can be, for example and without limitation, a processor, microcomputer, minicomputer, server, mainframe, laptop, personal data assistant (PDA), wireless email device, cellular phone, pager, processor, fax machine, scanner, or any other programmable device configured to transmit and/or receive data over a network. Computer systems and computer-based devices disclosed herein can include memory for storing certain software modules used in obtaining, processing, and communicating information. It can be appreciated that such memory can be internal or external with respect to operation of the disclosed embodiments. The memory can also include any means for storing software, including a hard disk, an optical disk, floppy disk, ROM (read only memory), RAM (random access memory), PROM (programmable ROM), EEPROM (electrically erasable PROM) and/or other computer-readable media. Non-transitory computer-readable media, as used herein, comprises all computer-readable media except for a transitory, propagating signals.

In various embodiments disclosed herein, a single component can be replaced by multiple components and multiple components can be replaced by a single component to perform a given function or functions. Except where such substitution would not be operative, such substitution is within the intended scope of the embodiments.

Some of the figures can include a flow diagram. Although such figures can include a particular logic flow, it can be appreciated that the logic flow merely provides an exemplary implementation of the general functionality. Further, the logic flow does not necessarily have to be executed in the order presented unless otherwise indicated. In addition, the logic flow can be implemented by a hardware element, a software element executed by a computer, a firmware element embedded in hardware, or any combination thereof.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

1. A method for providing depth perception from an image taking with a monocular camera in a confined space, the method comprising:
identifying a location of a camera collecting image data indicative of a video captured in a confined space;
selecting image data indicative of a single image from the collected image data at a designated location;
processing the image data indicative of a single image and developing image depth data based on the processed image data;
overlaying the image depth data onto the selected image from the selected image data indicative of the single image;
identifying a location of one or more objects in the image based on the known location and the image depth data; and
determining real-world geo-location coordinates for the identified one or more objects in the selected image based on the identified location of the objects.

2. The method of claim 1, further comprising disposing the camera on a vehicle and running the vehicle through the confined space.

3. The method of claim 1, wherein the camera is configured to be disposed on a floating vehicle that is floating on liquid flowing through a pipe.

4. The method of claim 1, wherein selecting the designated location comprises identifying one or more anomalies present in the confined space.

5. The method of claim 4, wherein the processing the image data indicative of a single image comprises determining a depth of one or more of the following relative to each other in the confined space:
space;
one or more walls;
the one or more objects; and
the one or more anomalies.

6. The method of claim 1, wherein processing the image data indicative of a single image comprises determining a depth of space depicted in the captured image.

7. The method of claim 1, wherein processing the image data indicative of a single image comprises determining a distance of the one or more objects from the camera.

8. The method of claim 1, comprising using a remote processor to process the image data indicative of a single image, the processing performed by a machine learning algorithm.

9. The method of claim 8, comprising training the machine learning algorithm to develop the image depth data using one or more of the following: raw RGB image data of similar confined spaces; three-dimensional reconstructed CAD models; and synthetic 3D model image data of similar confined spaces.

10. The method of claim 9, wherein the synthetic image data of the similar confined spaces is determined by identifying standard pipe and/or tunnel sizes, and reconstructing the confined space as a synthetic 3D model using the standard pipe and/or tunnel sizes.

11. The method of claim 9, wherein the machine learning algorithm is trained by using a virtual camera in the synthetic 3D model and generating synthetic images of an interior of a similar confined space.

12. The method of claim 11, wherein different virtual variables are used to aid in teaching the machine learning algorithm, comprising one or more of: an anomaly, damage, blockages, diverging and/or converging pipes and/or tunnels, and pipes and/or tunnels entering to a main section of the confined space.

13. The method of claim 1, wherein selecting the designated location comprises a user visually identifying a location in the captured video where one or more objects and/or anomalies are present.

14. The method of claim 1, wherein the selecting of the image data indicative of a single image comprises taking a screen grab of the captured video at the designated location and uploading the data indicative of a single image to a remote computing device comprising memory and a processor.

15. The method of claim 1, wherein processing the image data indicative of a single image comprises creating a bounding box around a portion of the selecting image comprising an area of interest.

16. The method of claim 1, wherein developing image depth data comprises using known dimensions of the confined space at the identified location to determined a distance of the one or more objects relative to each other and from the camera.

17. The method of claim 1, wherein developing image depth data comprises using colors and/or shading of the one or more objects, wherein lighter objects are closer to the camera and darker objects are further from the camera.

18. The method of claim 1, comprising identifying a type of object from the identified one or more objects, wherein the type of object comprises one or more of: a wall; an anomaly, damage, a blockage, a diverging and/or converging pipe and/or tunnel, and a pipe and/or tunnel entering to a main section of the confined space.

19. A system for providing depth perception from an image taking with a monocular camera in a confined space, the system comprising:
a vehicle that is configured to move through a confined space;
a camera disposed on the vehicle, the camera comprising a monocular image sensor that operably captures data indicative of a video;
a remote computing device comprising a processor memory to store data, the remote computing device configured to:
select image data indicative of a single image from the video at a designated location;
process the image data indicative of a single image, and developing image depth data based on the processed image data;
overlay the image depth data onto the selected image from the selected image data indicative of the single image;
identify a location of one or more objects in the image based on the known location and the image depth data; and
determine real-world geo-location coordinates for the identified one or more objects in the selected image based on the identified location of the objects.

20. A system for providing depth perception from an image taking with a monocular camera in a confined space, the system comprising:
a camera disposed on a vehicle that operably moves through a pipe or tunnel, the camera comprising a monocular image sensor that operably captures data indicative of a video;
a remote computing device comprising a processor memory to store data, the remote computing device configured to:
automatically select image data indicative of a single image from the video at a designated location based on preselected thresholds related to identification of one or more preselected objects identified in the video;
process the image data indicative of a single image using a pre-trained machine learning algorithm trained on synthetic 3D model image data of similar confined spaces, and developing image depth data based on the processed image data;
overlay the image depth data onto the selected image from the selected image data indicative of the single image;
identify a location of one or more objects in the image based on the known location and the image depth data; and
determine real-world geo-location coordinates for the identified one or more objects in the selected image based on the identified location of the objects.
